(19) United States
(12) Patent Application Publication
(10) Pub. No.: US 2010/0123645 A1
(43) Pub. Date: May 20, 2010

(54) UNIFIED NETWORK OF DISPARATE DISPLAY NETWORKS

(75) Inventors: G. S. Sridhar, Bangalore (IN); Vishwanath Ramdas, Bangalore (IN); Pradeep Bennur Teregowda, Bangalore (IN)

Correspondence Address: EVERGREEN VALLEY LAW GROUP, 4 North Second Street, Suite 598, SAN JOSE, CA, 95113, US

(73) Assignee: Techvoyant Infotech Pvt Ltd, Ulsoor (IN)

(21) Appl. No.: 12/525,550

(22) PCT Filed: Feb. 1, 2008
(86) PCT No.: PCT/IN2008/000065

§ 371 Date: Aug. 2, 2009

(30) Foreign Application Priority Data
Feb. 1, 2007 (IN) 235/CHE/2007

(51) Int. Cl. G09G 5/00

(52) U.S. Cl. 345/1.2

(57) ABSTRACT

A unified network of disparate display networks for displaying content provided by content providers through a service provider. Properties of disparate display network providers are defined by a service provider. Contents are then received from content providers. Further, the contents are filtered according to a set of predefined criteria and permissible display contents are selected based on the predefined criteria. These permissible display contents are displayed on display devices associated with disparate display networks of disparate display network providers.

### BACKGROUND

1. Technical Field

Embodiments of the invention generally relate to display networks, and more specifically to unifying disparate display networks.

2. Prior Art

Digital display networks have been in existence for several decades. The digital display networks have provided a medium for various content providers including product and services companies to advertise content at public locations where users are captive and close to the point of purchase. The digital display networks include several display devices to enable the content providers to advertise content and capture the users. Traditionally, the digital display networks are owned and managed by digital display network providers within a private domain, for example, a shopping mall network, corporate network or a public utility network (for example banks airports and railway stations). Various contending system models have been developed for controlling and managing the digital display networks.

Existing system models provide a privately managed and centrally controlled display system. A privately managed display system includes a single or a few administrative users to execute several tasks ranging from creating, distributing and scheduling the content to display devices. The privately managed display system does not provide feasibility to enable different content providers to advertise in the display devices owned by the respective digital display network providers. Hence, there is a lot of scope for improving the display systems so that different content providers can advertise in the display devices.

As an advance to the private display systems, a new range of publicly managed display systems have emerged which enable different content providers to advertise in the display devices. The digital display networks powering the publicly managed display systems provide both intelligent and basic services in identifying and deploying content within a single network. However, the publicly managed display systems lack the mechanism to bring together disparate digital display networks together and provide a single interface to different content providers to access different digital display networks. Moreover, the disparate display networks are set up to target various genres of audience. For example, some network organizations setup digital display networks for public consumption, some for their internal organization needs and some other for their private clientele audience. Hence, content displayed varies depending on the target audience. Additionally, many digital display networks do not participate in a single monolithic public display network. Therefore a content provider will have to go through multiple networks with small footprints, engage independent contracts with each digital network provider to reach a certain set of audience. This results in very low utilization of the digital display networks and high costs in managing and administering within the digital display networks.

Hence, there is a need for an improved system for distributing digital content to various electronic display devices of disparate digital display networks.

### SUMMARY

Embodiments of the invention disclosed herein provide a method and system for creating and managing a unified display network from disparate display network providers through a service provider.

An exemplary embodiment of the invention provides a method for creating a unified display network from disparate display network providers through a service provider. Properties of a disparate display network provider are defined. Contents from a content provider are then received. Further, the contents are filtered according to a predefined criterion and permissible display contents are selected. The permissible display contents are then displayed on a display device associated with a disparate display network of the disparate display network provider.

An exemplary embodiment of the invention provides a system for creating a unified display network from disparate display network providers through a service provider. The system includes a profile management module for defining properties and tags of a disparate display network provider. The system also includes a permission management module for checking permissions in a display device with respect to contents received from a content provider. Further, the system includes a content editing module for filtering the contents according to a predefined criterion and for selecting only permissible display contents.

An exemplary embodiment of the invention provides a method for controlling a unified display network. A request for displaying a content from a content provider is received. A set of specifications of a display device and a format of the content is defined by the content provider. Availability of the display device is then checked according to the set of specifications defined by the content provider. Further, a list of display devices available is provided in response to the request.

An exemplary embodiment of the invention provides a communication system utilized by a service provider for managing a unified display network of disparate display networks. The system includes a content provider enabled to interact with the service provider for displaying a content on a display device. The system also includes a disparate display network provider possessing the display device, registered with the service for advertising the content provided by the content provider. Further the system includes a database maintained by the service provider for managing data corresponding to the content provider and the disparate display network provider.

An exemplary embodiment of the invention provides a machine-readable medium product including a machine readable program code for enabling a service provider to create and manage a unified display network. The machine readable program code performs receiving a request for displaying a content from a content provider. A format of the content intended for displaying on a display device and a set of specifications of the display device is defined by the content provider. The machine readable program code also performs checking availability of the display device according to the set of specifications defined by the content provider. Further, the machine readable program code performs providing a list of display devices available in response to the request.

Other aspects and example embodiments are provided in the Figures and the Detailed Description that follows.

### BRIEF DESCRIPTION OF THE DRAWINGS

FIG. 1 is a flow diagram illustrating steps performed by the service provider in a method for providing a unified display network according to an embodiment of the invention;

FIG. 2 is a flow diagram illustrating the steps performed by disparate display network providers for registering to the service provider's network according to an embodiment of the invention;

FIG. 3 is a block diagram of a system for creating a unified display network according to an embodiment of the invention;

FIG. 4 is flow diagram illustrating the steps in a method performed by the service provider for controlling a unified display network according to an embodiment of the invention;

FIG. 5 is a block diagram illustrating a communication system utilized by the service provider for managing a unified display network according to an embodiment of the invention; and

FIG. 6 is a block diagram of an exemplary computer system upon which various embodiments of the invention may be implemented.

### DETAILED DESCRIPTION OF THE EMBODIMENTS

Embodiments of the invention disclosed herein provide methods and systems for creating and managing a unified display network from disparate display network providers through a service provider.

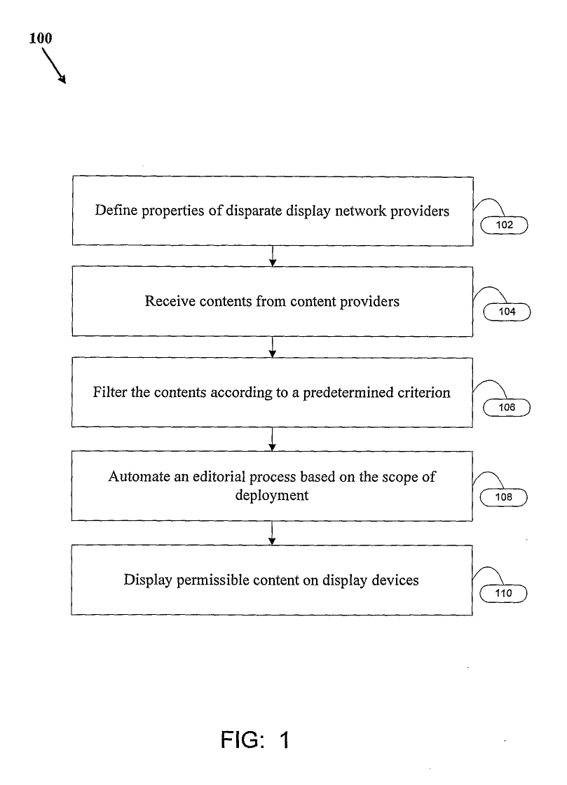

FIG. 1 is a flow diagram 100 illustrating steps performed by the service provider in a method for providing a unified display network according to an embodiment of the invention. Embodiments of the invention provide a mechanism through which a service provider creates and manages a unified display network by integrating disparate display networks. Rules, policies and mechanisms under which the disparate display networks can work together and co exist as a single medium for content delivery, without harming each others products and service offerings are described. Further, a platform for multiple content providers to advertise content in any display device possessed by different disparate display networks is provided. The method for providing a unified display network is explained in detail in the following paragraphs.

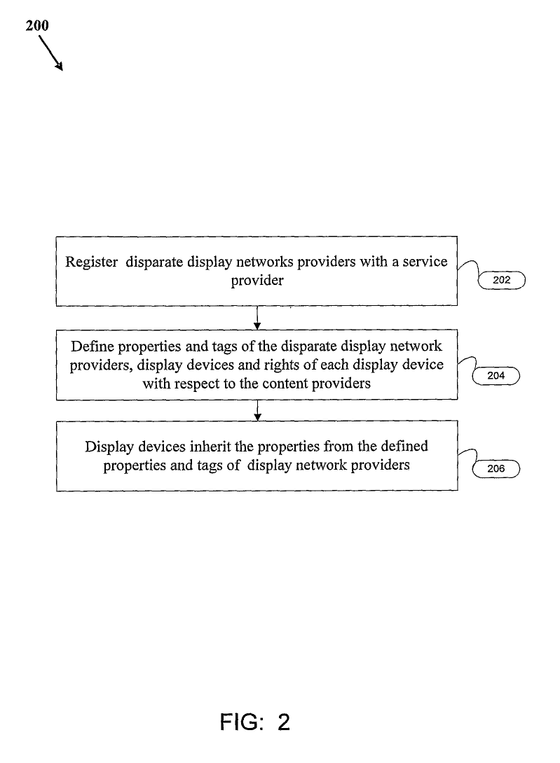

Disparate display network providers possess display devices for displaying contents. At step 102, properties of the disparate display network providers are defined. The properties may include terms and conditions agreed between the service provider and the disparate display network providers. The properties are defined to unite disparate display network providers and create a unified network by defining terms and conditions individually for each of the disparate display network providers. Further, the disparate display network providers are registered with the service provider. The steps for registering the disparate display network providers are explained in FIG. 2.

After defining properties of the disparate display networks contents are received from content providers at step 104. For example, a content from XYZ are received. XYZ may issue content including a brief description of a holiday location. At step 106, the contents are filtered according to a predetermined criterion. The predetermined criterion may include but not limited to, language sensitivity, ethical sensitivity and geographic location. The contents are stored and judged based on the predetermined criteria. As considered in the example, the content issued by XYZ is scrutinized based on the language and description of the holiday location as well as the locations chosen by XYZ for displaying the content. Further, information about content providers, disparate display network providers and display devices is also stored. Information about the content providers may include but not limited to the format of the content sent by the content providers and identification details of the content providers. Further, information about registration details of the disparate display network providers, details of display devices including number of display devices possessed by the disparate display network providers and types of display devices are also stored. The contents are also tested through an editorial process. The editorial process is automated based on the scope of deployment (whether private or public) at step 108.

In an embodiment of the invention, the scope of content deployment is broadened thereby creating one universal display network where third-party organizations can access all display devices through a single interface. Properties for every display device are associated within the unified display network, where rights are assigned independently to each major participant organization. The organization can be an owner, a partner with respect to the display device or a virtual public organization where the third-party organization group possesses the rights.

After filtering and editing process, display devices are identified by communicating with the disparate display networks according to the properties defined by the content providers. A set of properties are compared between the display devises and the contents. The properties may include but not limited to, dimensions of the display devices, time period for displaying the content and geographic locations of the display devices. Further, display properties of the display devices are also compared with the content for displaying on the display devices. At step 110, permissible content is displayed on the display devices. In an embodiment of the invention, permissible content is created subsequent to the filtering and the editing process.

FIG. 2 is a flow diagram 200 illustrating the steps performed by disparate display network providers for registering to the service provider's network according to an embodiment of the invention.

At step 202, disparate display network providers are registered with the service provider. In an embodiment of the invention, disparate display network providers include both public display network providers and private display network providers. At step 204, properties and tags of the disparate display network providers, display devices and rights of each display device with respect to the content providers are defined to register the disparate display network providers.

Further, at step 206, the properties from the respective disparate display networks are inherited by the display devices. As explained earlier, properties defined for the disparate display networks may include terms and conditions agreed between the service provider and the disparate display network providers. In parallel, the content providers are provided with properties and tags on what type of content is being created and the contents are provided with properties and tags about the content providers. This provides a mechanism for exempting confusion between different content providers to avoid conflict between the different content providers.

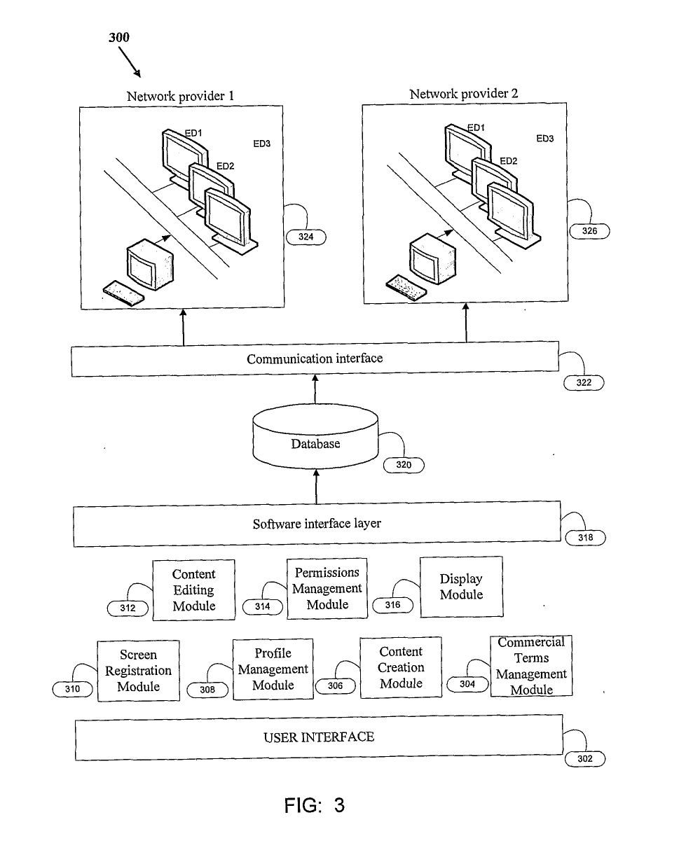

FIG. 3 is a block diagram of a system 300 for creating a unified display network according to an embodiment of the invention.

The system 300 includes a user interface 302 to enable content providers to access to the modules in the system 300. The system 300 further includes a plurality of disparate display network providers including network provider 324 and network provider 326. The system 300 also includes a commercial terms management module 304 for defining a set of predetermined conditions between the service provider and the disparate display network providers (324 and 326). Further, the system 300 includes a content creation module 306 for creating display contents and a profile management module 308 for defining properties and tags of the disparate display network providers (324 and 326). The system 300 also includes a screen registration module 310 for performing registration procedures according to the pre-defined set of conditions agreed between the service provider and disparate display network providers (324 and 326). Further, the system 300 includes a content editing module 312 for filtering contents according to a set of pre-defined conditions and selecting only permissible display contents and a permissions management module 314 for checking permissions in display devices (324 and 326) with respect to the contents. The system 300 also includes a display module 316 for displaying permissible content. The system 300 further includes a software interface layer 318 to co ordinate between the modules of the system 300. The system 300 also includes a database 320 for storing information about the service provider and the disparate display content providers (324 and 326) and a communication interface 322 to enable communication with the disparate display network providers (324 and 326).

Content providers register with the service provider to access various modules of the system 300 through the user interface 302. In an embodiment of the invention, the content providers are exempted of the registration charges. As a parallel process, disparate display network providers are also registered with the service provider through the screen registration module 310. The registration process is as explained in FIG. 2.

The content providers place a request to the service provider to display content on the display devices possessed by the disparate display networks (324 and 326). As considered in the previous example, XYZ interacts with the service provider through the user interface 302 and places a request for displaying content including a brief description of a holiday location. XYZ may specify geographic locations to display the content. The information regarding the content is stored in the database 320. The information about the disparate display network providers and the respective display devices is also stored in the database 320. Content editing module 312 is used for filtering and editing the content according to a set of predefined conditions. As explained earlier, the set of predefined conditions may include but are not limited to language sensitivity, ethical sensitivity and geographic location. A mechanism for checking the appropriateness of the content is also deployed.

Further, the profile management module 308 defines the properties and tags of the disparate display network providers (324 and 326). In an embodiment of the invention, tags and properties of the display devices are also defined. Additionally, the system 300 provides access to only those display devices possessed by disparate display networks (324 and 326) where the permissions are made available based on a comparison of the properties of the content with the properties and tags of the disparate display networks (324 and 326) and respective display devices. This ensures that the content being deployed is not in conflict with the interest of the owner of the display network and at the same time the content is appropriate for public display within the context of the display devices. The content editing module 312 then selects permissible display contents subsequent to the editing and filtering process.

Software interface layer 318 enables the service provider to coordinate between the various modules of the system 300 and form a single unique interface in conjunction with the database 320 and the communication interface 322. In an embodiment of the invention, the communication interface 322 may utilize a network layer to enable communication, addressing and routing between the disparate display networks (324 and 326). In another embodiment of the invention, the software interface layer 318 may utilize a link layer to link between various modules of the system 300. In yet another embodiment of the invention, the database 320 may include complex algorithms to facilitate large storage of data. After filtering and editing the contents, the permissions management module 314 is used for checking permissions in display devices (324 and 326) with respect to the contents. The properties defined by the content providers are matched with the display devices. For example, dimensions of the display devices provided by XYZ are matched with the display devices possessed by disparate display network providers (324 and 326). Further, permissible content is displayed on the display devices using the display module 316

In the system 300, a rewarding mechanism is provided for the disparate display network providers (324 and 326) through revenue sharing and rentals to ensure that the commercialization and ownership of the display devices is not only minimal but also profitable. Also, the system 300 provides a control mechanism to the disparate display network providers (324 and 326) to manage the commercialization of the respective display networks, define the properties and tags for the respective display networks for content & organization, and industry permissions along side with a user management system for working within the context of the organization.

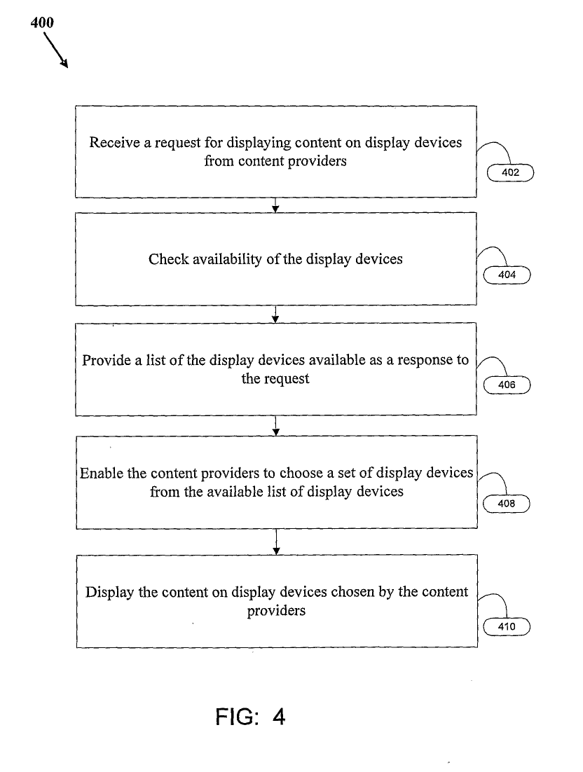

FIG. 4 is flow diagram 400 illustrating the steps in a method performed by the service provider for controlling a unified display network according to an embodiment of the invention. At step 402, a request for displaying content from content providers is received. The content providers define properties and format of the content intended for displaying on display devices. The content. providers may specify a plurality of properties including but not limited to geographic locations for displaying the content, dimensions of the display devices and time period for displaying the content. In an embodiment of the invention, the content providers are provided with the liberty of sending the content in any format. After receiving the request, availability of the display devices is checked at step 404. Disparate display network providers (324 and 326) possessing the display devices are registered. The steps for registering the disparate display networks providers (324 and 326) to the service provider's network are as explained in FIG. 2. The disparate display network providers (324 and 326) are provided with a control mechanism for managing commercialization of the respective disparate digital display networks. The control mechanism is provided by defining a set of properties and tags for the disparate display networks. Further, the disparate display network providers (324 and 326) are rewarded for managing the commercialization of the respective disparate display networks.

The availability of the display devices is checked by communicating with the disparate display network providers (324 and 326). The display devices are scrutinized based on the properties specified by the content providers. Further, the display devices satisfying the properties specified by the content providers are listed. At step 406, the list of available display devices is then provided to the content providers as a response to the request. In an embodiment of the invention, a dynamic update of available display devices is provided to the content providers if the display devices as requested by the content providers were not available. The service provider may send an update confirming the availability of the display devices to the content providers when the display devices are available. Thereafter, at step 408, the content providers are enabled to choose a set of display devices from the available list of display devices for displaying the content by booking the display devices. The service provider then converts the format of the content received from the content providers to a format as specified by the respective disparate display network providers (324 and 326) to enable display of the content. Therefore, the content providers are not required to send the content in a format specified by disparate display network providers. Further, the hassle of registering with the disparate display network providers is also avoided since the content providers can directly book any display device possessed by any disparate display network provider through the service provider. Further, at step 410, the content is displayed on the display devices chosen by the content providers. In an embodiment of the invention, the service provider may send a status update to the content providers. For example, after the content is displayed on the display devices, the service provider may inform the content providers that the content has been displayed.

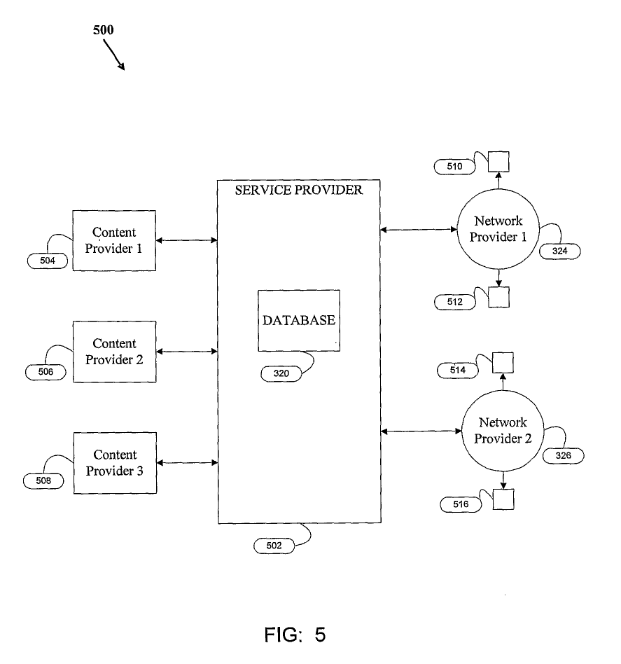

FIG. 5 is a block diagram illustrating a communication system 500 utilized by the service provider for managing a unified display network according to an embodiment of the invention.

System 500 includes a service provider 502 for creating and managing a unified display network. The system 500 also includes a plurality of disparate display network providers including network provider 324 and network provider 326 registered with the service provider 502. Network provider 324 and network provider 326 may be coupled to one or more display devices 510, 512 and 514, 516 respectively. Further, the system 500 includes a plurality of content providers including content provider 504, content provider 506 and content provider 508 enabled to interact with the service provider 502 for displaying content in the display devices (510,512, 514 and 516). The service provider may be coupled to a database 320 for managing data corresponding to the content providers (504, 506 and 508) and disparate display network providers (324 and 326).

The service provider 502 receives a request from the content providers (504, 506 and 508) for displaying content on the display devices (510, 512, 514 and 516). The display devices (510,512, 514 and 516) may be different from each other with respect to dimensions and also with respect to disparate display networks (324 and 326). Examples of content may include but not limited to videos, audio files, posters and advertisements promoting various products of different companies. The service provider 502 then stores the details of the content received in the database 320. The details of the content may include a format of the content and various properties specified by the content providers (504,506 and 508). The service provider 502 uses the details stored in the database to check for availability of the display devices (510,512,514 and 516). In order to check for the availability of the display devices (510, 512, 514 and 516) the service provider 502 communicates with the disparate display network providers (324 and 326). The disparate display network providers (324 and 326) may be registered with the service provider 502 and are provided with a control mechanism to facilitate commercialization of the respective disparate display networks and display devices (510,512, 514 and 516). In an embodiment of the invention, the service provider 502 stores the registration details corresponding to the disparate display network providers (506 and 508) in the database 504. Further, the service provider 502 provides the content providers with a list of available display devices according to the properties specified by the content providers (510,512,514 and 516).

In an embodiment of the invention, several disparate digital display networks may be owned by the service provider 502 thereby exempting registration procedures.

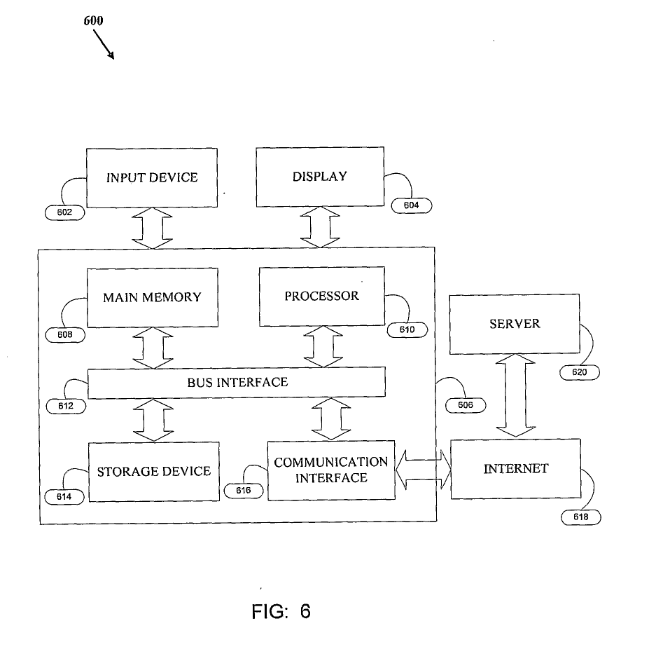

FIG. 6 is a block diagram of an exemplary computer system 600 upon which various embodiments of the invention may be implemented. Computer system 600 includes a processing unit 606 including a main memory 608, such as a Random Access Memory (RAM) or other dynamic storage device, coupled to a bus interface 612 for storing information and instructions to be executed by processor 610. A storage device 614, such as a magnetic disk or optical disk, is provided and coupled to bus interface 612 for storing information and instructions. Computer system 600 may be coupled via bus interface 612 to a display 604 for displaying information to a user. An input device 602, including alphanumeric and other keys, is coupled to bus interface 612 for communicating information and command selections to processor 610.

Embodiments of the invention are related to the use of computer system 600 for implementing the techniques described herein. In an embodiment of the invention, those techniques are performed by computer system 600 in response to processor 610 executing one or more sequences of one or more instructions included in main memory 608. Such instructions may be read into main memory 608 from another machine-readable medium product, such as storage device 614. Execution of the sequences of instructions included in main memory 608 causes processor 610 to perform the method embodiment of the invention described herein. In alternative embodiments, hard-wired circuitry may be used in place of or in combination with software instructions to implement the invention. Thus, embodiments of the invention are not limited to any specific combination of hardware circuitry and software.

The term “machine-readable medium product” as used herein refers to any medium that participates in providing data that causes a machine to operation in a specific fashion. Examples of the machine-readable medium product include but are not limited to memory devices, tapes, disks, cassettes, integrated circuits, servers, online software, download links, installation links, and online links.

In an embodiment implemented using computer system 600, various machine-readable medium products are involved, for example, in providing instructions to processor 510 for execution. Computer system 600 also includes a communication interface 616 coupled to bus interface 612. Communication interface 616 provides a two-way data communication coupling to internet 618 that is coupled a server 620. Server 620 might transmit a requested code for an application program through internet 618 and communication interface 616.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this detailed description, but only by the following claims.

What is claimed is:

1. A method comprising:
defining properties of a disparate display network provider;
receiving contents from a content provider;
filtering the contents according to a predefined criterion and selecting permissible display contents; and
displaying the permissible display contents on a display device associated with a disparate display network of the disparate display network provider.

2. The method of claim 1, wherein the receiving further comprises:
receiving the contents in a format defined by the content provider.

3. The method of claim 1, wherein the filtering further comprises:
storing information about the display network provider and the content provider; and
comparing display properties of the display device with properties of the contents.

4. The method of claim 3, wherein the storing further comprises:
storing information regarding registration details of the disparate display network provider; and
storing information about the contents received from the content provider.

5. The method of claim 1, wherein the defining further comprises:
registering the disparate display network provider;
defining properties and tags of the display device; and
defining the rights of each of the display device with respect to the content provider.

6. A system comprising:
a profile management module for defining properties and tags of a disparate display network provider;
a permission management module for checking permissions in a display device with respect to contents received from a content provider; and
a content editing module for filtering the contents according to a set of predefined criteria and for selecting only permissible display contents.

7. The system of claim 6 further comprising:
a screen registration module for registering the disparate display network provider with a service provider;
a commercial terms management module for defining a set of terms between the service provider and the disparate display network provider;
a content creation module for creating display contents;
a displaying module for displaying the permissible display contents; and
a database for storing information about the contents and the content provider.

8. The system of claim 7, wherein the database further stores information about registration details of the disparate display network provider.

9. A method comprising:
receiving a request for displaying a content from a content provider comprising a format of the content intended for displaying on a display device wherein the content provider defines a set of specifications of the display device;
checking availability of the display device according to the set of specifications defined by the content provider; and
providing a list of display devices available in response to the request.

10. The method of claim 9 wherein the defining specifications comprising:
defining dimensions of the display device; and
defining a location of the display device.

11. The method of claim 9, wherein the checking further comprises:
registering a disparate display network provider possessing the display device; and
communicating with the disparate display network provider for checking the availability of the display device.

12. The method of claim 9 further comprising:
providing a control mechanism to the disparate display network provider for managing commercialization of respective disparate display networks; and
rewarding the disparate display network provider for managing the commercialization of the respective disparate display networks.

13. The method of claim 12, wherein the providing further comprises:
defining a set of properties and tags for the respective disparate display networks.

14. A system comprising:
a content provider enabled to interact with a service provider for displaying a content on a display device;
a disparate display network provider possessing the display device, registered with the service provider for advertising the content; and
a database maintained by the service provider for managing data corresponding to the content provider and the disparate display network provider.

15. The system of claim 14, wherein the database further stores information about the content provider and the disparate display network provider.

16. The system of claim 14, wherein the disparate display network provider comprises a public disparate display network provider.

17. The system of claim 14, wherein the disparate display network provider comprises a private disparate display network provider.

18. A machine-readable medium product comprising instructions operable to cause programmable processor to perform:
receiving a request for displaying a content from a content provider comprising a format of the content intended for displaying on a display device wherein the content provider defines a set of specifications of the display device;
checking availability of the display device according to the set of specifications defined by the content provider; and
providing a list of display devices available in response to the request.

19. The machine-readable medium product of claim 18, wherein the checking further comprising instructions operable to cause a programmable processor to perform:
registering a disparate display network provider possessing the display device; and
communicating with the disparate display network provider for checking the availability of the display device.

20. The machine-readable medium product of claim 18 further comprising instructions operable to cause a programmable processor to perform:
providing a control mechanism to the disparate display network provider for managing commercialization of respective disparate display networks; and
rewarding the disparate display network provider for managing the commercialization of the respective disparate display networks.
